(19) United States
(12) Patent Application Publication
(10) Pub. No.: US 2002/0190139 A1
(43) Pub. Date: Dec. 19, 2002

(54) Spray nozzle with dispenser for washing pets

(76) Inventor: Mark D. Morrison, New York, NY (US)

Correspondence Address: HAYES SOLOWAY PC, 175 Canal Street, Manchester, NH, 03101, US

(21) Appl. No.: 10/171,268

(22) Filed: Jun. 12, 2002

Related U.S. Application Data
(60) Provisional application No. 60/297,922, filed on Jun. 13, 2001.

(51) Int. Cl. B05B 7/12; B05B 7/28

(52) U.S. Cl. 239/315; 239/413

(57) ABSTRACT

A pet washer is disclosed having separate actuators to control the flow of water and the flow of soap, shampoo, flea repellant or flea pesticide. The pet washer allows a user to wet, lather and rinse an animal. The washer may also be useful for washing cars and other vehicles.

### CROSS-REFERENCE TO RELATED APPLICATION

This application claims the benefit of copending U.S. provisional patent application serial No. 60/297,922 filed Jun. 13, 2001, the teachings of which are incorporated herein by reference.

### FIELD OF THE INVENTION

This invention relates to a spray nozzle for adding a liquid to an outgoing water stream and more particularly to a spray nozzle for washing pets with a self-contained reservoir for holding a liquid.

### BRIEF SUMMARY OF THE INVENTION

In accordance with the present invention, a spray nozzle for washing pets is provided in which an exiting water stream can alternately dispense water or a combination of water and a liquid detergent. A first actuator on the nozzle may control the flow rate and a second actuator may control the amount of detergent being added to the exiting water stream. The detergent may be stored in a reservoir located above the exiting water stream and enter the water stream by gravity or by a vacuum created by the water passing an opening in the reservoir. The nozzle may include a connector for coupling the nozzle to a source of water.

In accordance with the present invention, a novel spray nozzle assembly is provided for washing pets that has a reservoir for holding a quantity of a liquid detergent and a water flow channel. The assembly having two or more actuators, the first actuator controlling the flow rate of water through the flow channel and the second actuator for selectively dispensing the liquid detergent into the flow channel.

The above and other objects, feature, and advantages of the present invention will be apparent in the following detailed description thereof when read in conjunction with the appended drawings wherein the same reference numerals denote the same or similar parts throughout the several views.

### BRIEF DESCRIPTION OF THE DRAWINGS

FIG. 1 is a side view of a first embodiment spray nozzle consistent with the present invention;

FIG. 2 is a front view of the spray nozzle of FIG. 1;

FIG. 3 is a side view of a second embodiment spray nozzle consistent with the present invention;

FIG. 4 is a side view of a third embodiment spray nozzle consistent with the present invention;

FIG. 5 is a front view of the spray nozzle taken along line 5-5 of FIG. 4;

FIG. 6 is a section view of the spray nozzle taken along line 6-6 in FIG. 5;

FIG. 7 is a side view of a fourth embodiment spray nozzle consistent with the present invention; and

FIG. 8 is a side view of a fifth embodiment spray nozzle consistent with the present invention.

### DETAILED DESCRIPTION OF PREFERRED EMBODIMENTS

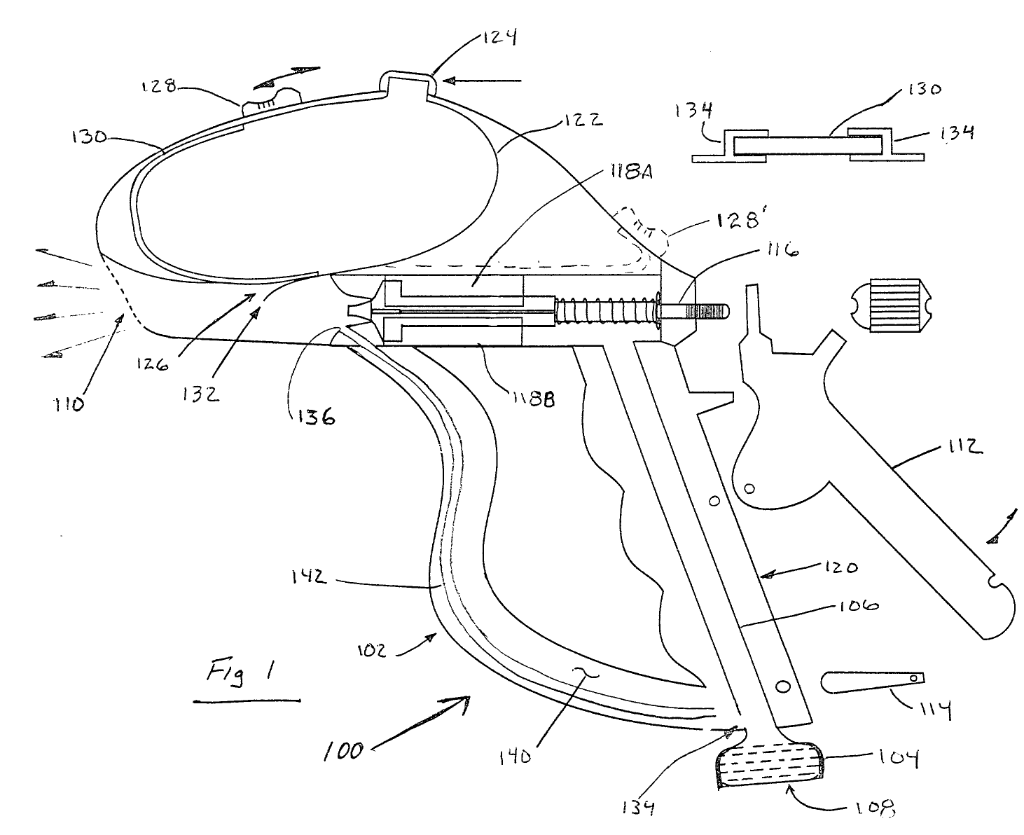

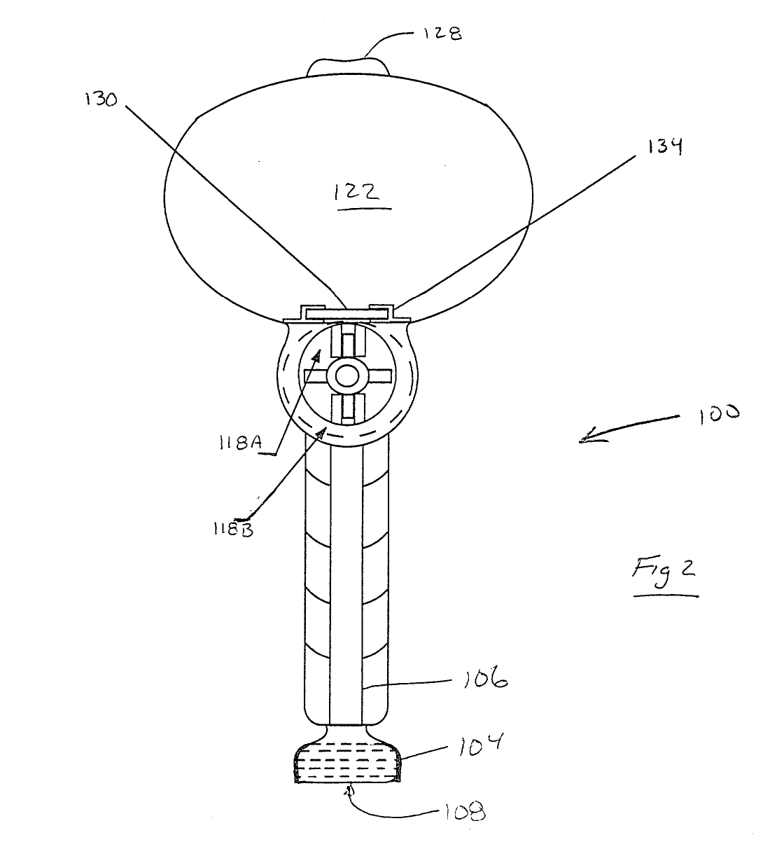

FIGS. 1 and 2 show a first embodiment nozzle assembly 100. The assembly includes a housing 102 with a handle portion 120 where a user may comfortably hold the assembly. The housing may be made from a polymeric material. The housing 102 may have a connector 104 for coupling the housing 102 to a source of water. The connector may be a ⅝″ female threaded connector for connection to a garden hose, but alternative connectors including quick release connectors are possible. The nozzle assembly 100 may alternatively be manufactured with a predetermined length of flexible hose.

Entering water travels through a flow channel 106 that extends from an inlet 108 to an outlet 110. A first actuator 112, preferably a rotatable trigger, may be mechanically coupled to the housing 102 or flow channel 106 to allow the user to control the flow rate of water through the flow channel 106. The first actuator 112 is shown separated from the housing for illustration purposes only. The actuator 112 may be capable of completely stopping the flow of water. The user may squeeze the actuator 112 towards the handle portion 120 to cause a plunger 116 to move along a path guided by plunger guides 118A and 118B. The plunger 116 may be positioned anywhere along the flow channel between the inlet 108 and the outlet 110. Alternatively, the actuator 112 may control a valve, for example a ball valve.

The assembly may also include a locking mechanism 114 to hold the actuator 112 in a fixed position without the user having to provide any force. Alternatively, the actuator may be moveable between a plurality of positions and may not require any force to keep the actuator in the desired position.

Water may exit the nozzle assembly 100 through the outlet 110. The outlet 110 may comprise a plurality of fixed or adjustable openings. The user may position one of the openings in front of the exiting water stream to adjust the spray pattern. The layout of the openings determines the exit water pattern and may be adjustable between a narrow and a wide stream. Alternatively, the exit water pattern may be controlled by the position of the plunger 116.

A reservoir 122 for holding a liquid may be located above the plunger 116. The liquid may include soap, shampoo, conditioner, flea repellant, or flea pesticide. Preferably, the reservoir 122 is designed to hold 2-10 oz of liquid. The liquid can be added to the reservoir 122 through a fill cap 124 which may include a vent to allow the liquid to drain freely. The reservoir 122 may include an opening 126 for allowing the liquid to flow from the reservoir 122 into the water stream. The opening 126 may be located on the inlet or outlet side of the plunger. The size of the opening in the reservoir 122 may be user adjustable through movement of a second actuator 128, such as a sliding thumb tab. The sliding thumb tab may be coupled to a flexible closer 130 and guided by a pair of “C” guides 134. The closer 130 may be moveable anywhere between a first position in which the opening from the reservoir 122 to the flow channel 106 is closed and a second position in which the opening is at its maximum. A deflector 132 may be located near the opening 126 in the reservoir 122. The deflector 132 may ensure proper mixing of the liquid and the water. The deflector 132 may also resist the flow of the liquid from the reservoir when there is no water flow. In the preferred embodiment, the water does not enter the reservoir.

The reservoir 122 may also include indicators in proximity to the second actuator 128 to indicate the opening size. Manufactures of liquid detergents such as soaps and shampoos disclose recommended dilution rates for their concentrated detergents and the indicators may be used to signal the user the proper second actuator position appropriate for the concentration of the liquid to be mixed. The second actuator 128 may include a plurality of detents to limit the number of available positions in which the thumb tab may be positioned. An alternative actuator 128′ may be located so that the user may actuate the second actuator while holding the handle portion 120 and/or the rotatable actuator/trigger 112.

In an alternative embodiment also shown in FIG. 1, a reservoir 140 may be incorporated into the housing 102. At least a portion of the housing may be translucent or transparent to allow a user to see the volume of liquid remaining. The liquid to be added may enter the water stream through an opening 134 at the base of the handle portion 120 prior to the plunger 116. The liquid may enter the water channel by gravity or by the vacuum created by the water traveling through the flow channel 106 and passing the opening 134. In another alternative embodiment (also shown in FIG. 1), an opening 136 may be located between the plunger 116 and the outlet 110. The liquid may enter the flow channel by the vacuum created by the water traveling through the flow channel and passing the opening 136. A tube 142 may be used to siphon liquid from the bottom of the reservoir 140.

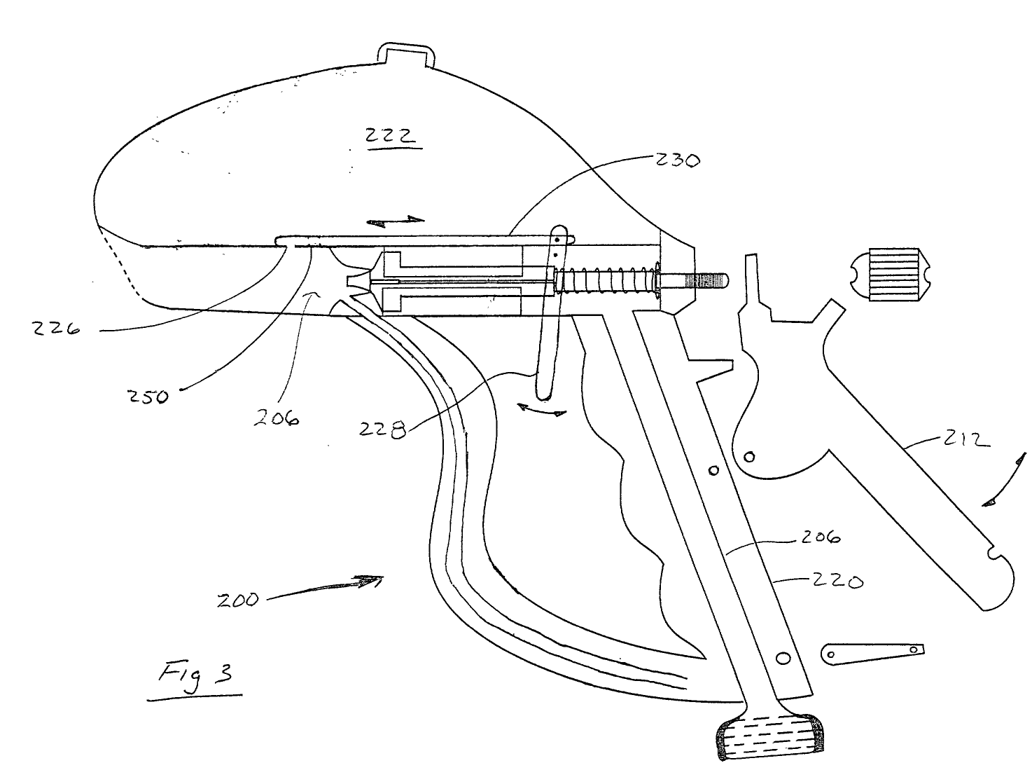

A second actuator similar to 128, 128′ or 228 (see FIG. 3) may be used to open or close the openings 134 and 136.

To wash a pet, the user first actuates the first actuator 112 to wet the pet. When the user wants to add soap, shampoo, conditioner, flea repellant, or flea pesticide to the resulting water stream, the user positions the second actuator 128 or 128′ into an appropriate position between closed and fully open. To rinse the pet, the user returns the second actuator 128 or 128′ to the closed position

FIG. 3 shows a second embodiment nozzle assembly 200. The assembly 200 includes a first actuator 212 and a second actuator 228. The second actuator 228 is preferably a rotatable lever and is coupled to a closer 230. The closer 230 may be capable of movement anywhere between a first position and a second position. In the first position the closer 230 blocks an opening 226 between a reservoir 222 and the flow channel 206. In the second position an opening 250 on the closer 230 aligns with the opening 226 between the reservoir 222 and the flow channel 206 to allow the liquid to flow from the reservoir 222 into the flow channel 206. The second actuator 228 is preferably located in close proximity to a handle portion 220 where a user can grab the assembly. The user may rotate the second actuator 228 towards the handle portion 220 to cause liquid to be added to the water stream. The nozzle assembly 200 may further include return mechanisms, for example springs, to return the first and second actuators to a “closed” position when released.

To wash a pet, the user first actuates actuator 212 to wet the pet. When the user wants to add soap, shampoo, conditioner, flea repellant, or flea pesticide to the resulting water stream, the user actuates actuator 228. To rinse the pet, the user releases the second actuator 228.

A plurality of flexible “fingers” may be coupled to the assembly 100 or 200 to help work the soap, shampoo, conditioner, flea repellant, or flea pesticide into a pet's coat. Alternatively, the nozzle may be used for washing vehicles such as car, trucks, and boats.

A rotatable or slidable trigger lock may also be incorporated to prevent accidental discharge of water.

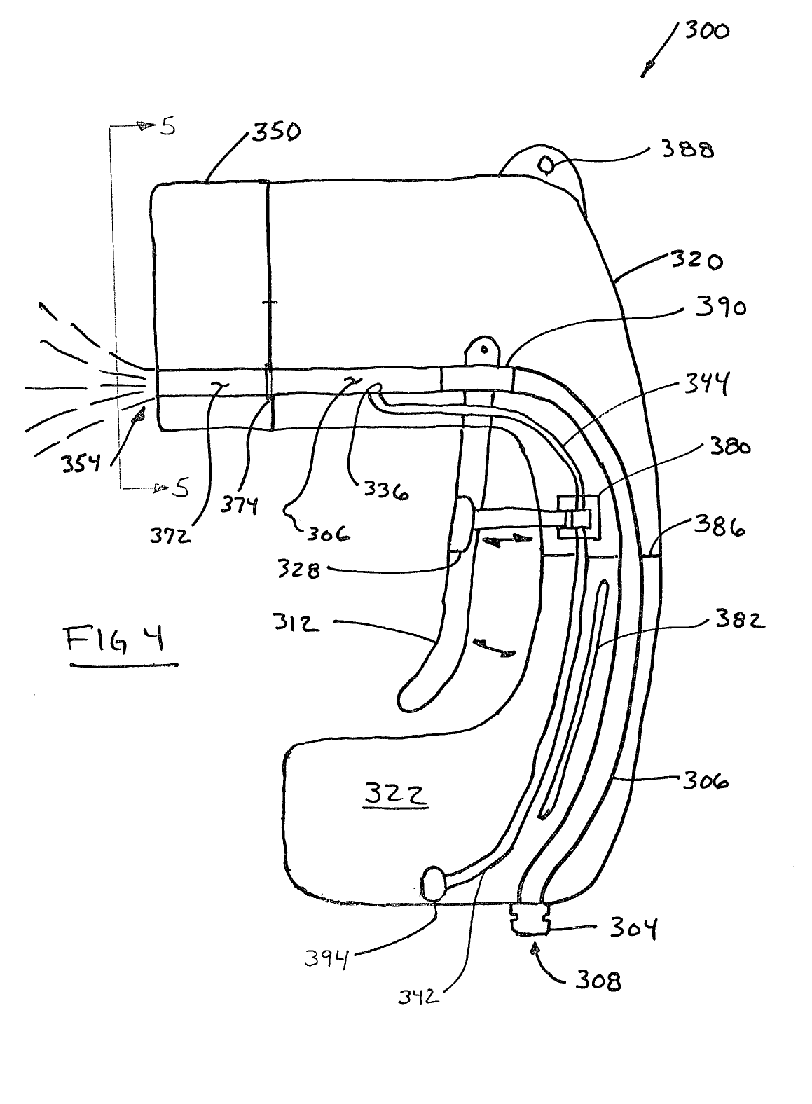

FIGS. 4-6 show a third embodiment nozzle assembly 300. The assembly includes a housing 320 having a handle portion where a user may comfortably hold the assembly. The housing 320 may have a connector 304 located along the base for coupling to a source of water. Alternatively, the connector 304 may be located along the side of the housing 320 to allow the assembly to stand up right. The connector may be a ⅝″ female threaded connector for connection to a garden hose, but alternative connectors including quick release connectors are possible. Alternatively, the assembly may be manufactured with a predetermined length of flexible hose. The housing 320 may be made in separate piece and coupled using ultrasonic welding or may rely on a mechanical coupling.

Entering water travels through a flow channel 306 that extends from an inlet 308 to a rotatable nozzle adapter 350. A first actuator 312, preferably a rotatable trigger, may be mechanically coupled to the housing 302 and/or a valve 390 located at least partially within the flow channel 306 to allow the user to control the flow rate of water. The actuator 312 may be capable of completely stopping the flow of water. The valve 390, for example a ball valve, may be positioned anywhere along the flow channel 306. The assembly 300 may further include a locking mechanism to hold the actuator 312 in a fixed position without the user having to provide any force.

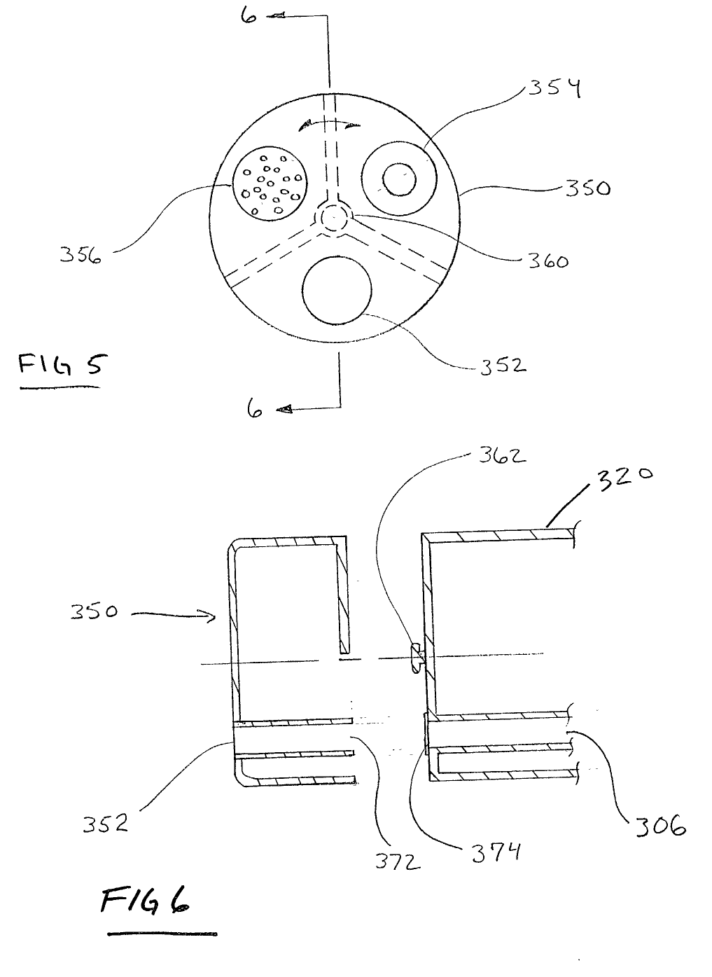

The water may exit the assembly 300 through an outlet 352, 354, 356 located in the rotatable nozzle adapter 350 (see FIG. 5). Outlet 352 allows the water and any added liquid to exit without any substantial reduction in channel size, outlet 354 may reduce the channel size to increase the exiting water stream velocity, and outlet 356 may include a plurality of openings to provide an exiting water spray. Other outlet configurations are possible.

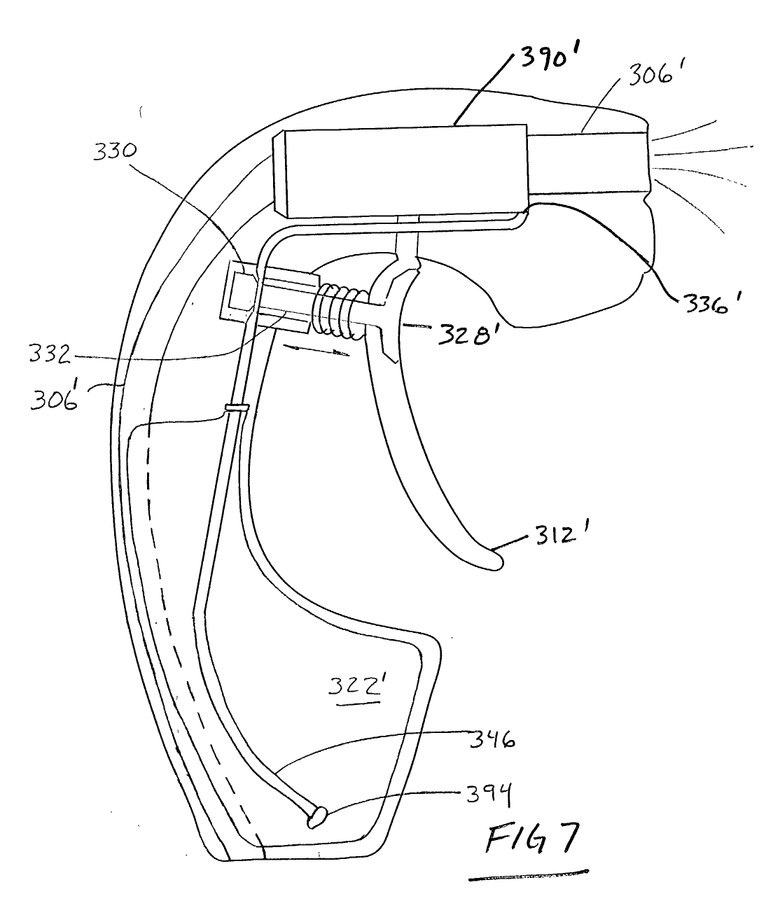

FIG. 6 shows a water channel 372 that couples water channel 306 to outlet 352. The user may rotatably align any one of the outlets 352, 354, 356, with the flow channel 306. A washer 374 may be used to reduce leakage. The rotatable nozzle adaptor 350 may have a feature 360 that allows it to rotate about a center point 362 located on the housing 320. Alternatively, the nozzle may be circumferentially secured to the housing 320. Alternatively, the nozzle may be translatable and not rotatable.

A reservoir 322 for holding a liquid may be located near the base of the housing 320. A divider 386 may keep the liquid contained to the base of the housing 320. The liquid may include soap, shampoo, conditioner, flea repellant, or flea pesticide. Preferably, the reservoir 322 is designed to hold 2-10 oz of liquid. The liquid can be added to the reservoir 322 through a fill cap that allows the liquid to drain freely.

An actuator 328 may be incorporated in actuator 312 and may be separately actuatable. The actuator 328 may control a valve 380. The valve 380 may be connected on one side to a tube 342 that extends into the reservoir 322 and on the other side to a tube 344 that is coupled to the flow channel 306 at an opening 336 or to valve 390. In a first position, the valve 380 prevents the flow of liquid from the reservoir 322 to the opening 336 and in a second position, the valve 380 allows liquid from the reservoir 322 to flow to the opening 336. Water traveling through the flow channel 306 and passing the opening 336 creates a vacuum that causes the liquid to be siphoned from the reservoir 322 through tubes 342 and 344. Preferably, the actuator 328 may only be actuatable if actuator 312 is actuated. A weight 394 may be coupled to the lower end of the tube 342 to cause the tube to seek the lowest point in the reservoir 322. The weight may be made of any material denser than the liquid in the reservoir 322.

Alternatively, a reservoir may be located above the flow channel 306 and the liquid may enter the flow channel 306 by gravity.

The reservoir 322 may have a translucent or transparent window 382 that allows a user to visually determine the remaining volume of liquid in the reservoir 322.

The housing 320 may have an opening 388 to allow the assembly to be suspended by a cord, preferably a retractable cable.

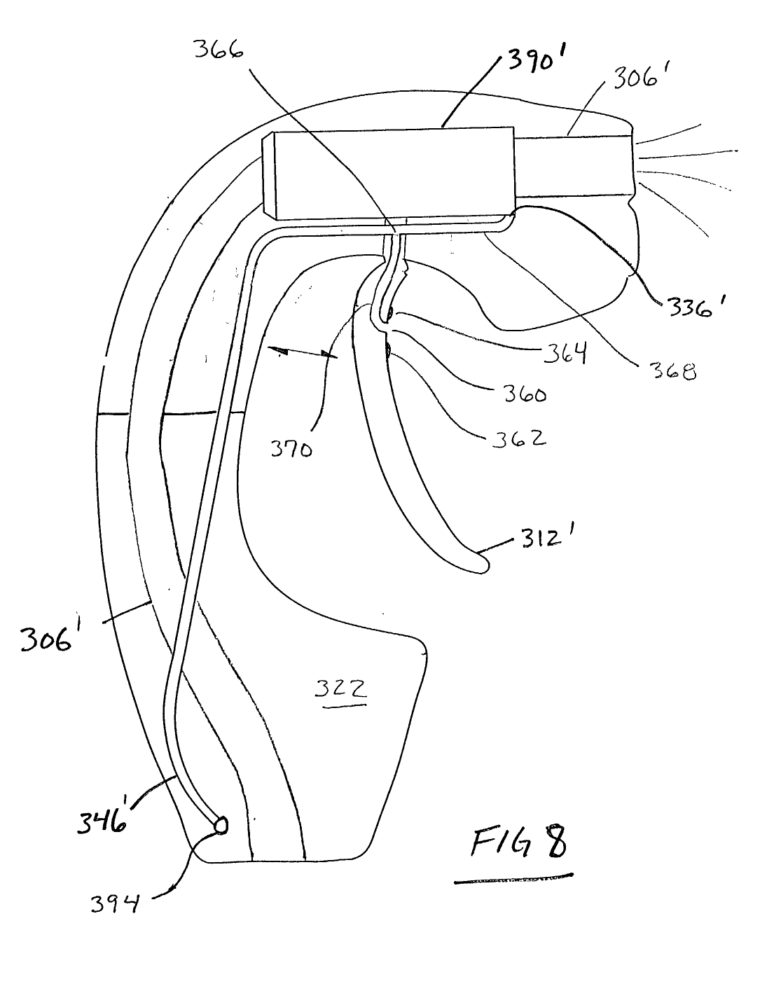

As shown in FIG. 7, a single tube 346 may extend from the reservoir 322′ to a valve 390′ (or alternatively the flow channel 306′) at an opening 336′. As discussed above, actuation of a first actuator 312′ allows water to flow through flow channel 306′. A second actuator 328′ may be coupled to a shaft 332 that is coupled to a crimper 330. When the actuator 328′ is in the unactuated (rest) position, the crimper 330 provides a compressive force on the walls of the tube 346 to prevent the flow of liquid from the reservoir 322′. When the actuator 328′ is in the actuated position, the crimper does not substantially resist the flow of liquid through the tube 346. The tube 346 may extend into a container 322′ that is separable from the housing 320. The container 322′ may be formed as one piece, for example by blow molding. The one-piece construction reduces the potential of leaking as compared to separate pieces that are coupled, for example by ultrasonic welding. The container 322′ may include a recess to allow the flow channel 306 to extend there past.

As shown in FIG. 8, a single tube 368 may extend from an opening 336′ in valve 390′ or flow channel 306′ to ajunction 366 where the single tube 368 splits into two separate tubes. The first tube 346′ extends from the junction 366 to the reservoir 322 and the second tube 370 extends from the junction 366 to an opening 360 preferably located on the first actuator 312′. The opening 360 may be located between a pair of protrusion 362, 364 that may aid the user in quickly finding the opening 360 using tactile feedback. As discussed above, actuation of a first actuator 312′ allows water to flow through flow channel 306′. To add the liquid from the reservoir 322 to the resulting water stream, the user simply covers the opening 360 with a finger.

It should be understood that various features and options disclosed herein may be combined and are within the scope of the present invention.

It should be understood that, while the present invention has been described in detail herein, the invention can be embodied otherwise without departing from the principles thereof, and such other embodiments are meant to come within the scope of the present invention as defined in the following claims:

I claim

1. A spray nozzle assembly for washing pets, comprising:
a flow channel;
a reservoir for holding a quantity of liquid detergent;
a first actuator for controlling the flow rate of water through the flow channel; and
a second actuator for selectively dispensing the liquid detergent into the flow channel through an opening in the flow channel.

2. The spray nozzle assembly of claim 1 wherein the first actuator is rotatable about the housing.

3. The spray nozzle assembly of claim 1 wherein the second actuator is rotatable about the housing.

4. The spray nozzle assembly of claim 1 wherein the second actuator is a linearly translatable about the housing.

5. The spray nozzle assembly of claim 1 further comprising a locking mechanism to maintain the flow of water through the flow channel without the addition of force by a user.

6. The spray nozzle assembly of claim 1 wherein the reservoir is disposed above the flow channel.

7. The spray nozzle assembly of claim 1 wherein the second actuator allows a user to adjust the application rate of the detergent.

8. The spray nozzle assembly of claim 1 further comprising a plurality of flexible finger coupled to the housing to work the detergent into a pet's coat.

9. The spray nozzle assembly of claim 1 further comprising a rotatable nozzle for varying the water stream exiting the nozzle assembly.

10. The spray nozzle assembly of claim 1 further comprising a tube having a first end coupled to an opening in the flow channel and a second disposed in the reservoir.

11. The spray nozzle assembly of claim 10 further comprising a valve disposed between the first end and the second end of the tube.

12. The nozzle of claim 11 wherein the second actuator controls the quantity of liquid passing through the tube.

13. The spray nozzle assembly of claim 11 wherein the valve is variably adjustable.

14. The spray nozzle assembly of claim I further comprising a predetermined length of flexible tubing for coupling the sprayer to a source of water.

15. The spray nozzle assembly of claim 1 further comprising a return mechanism to return the first actuator to a position in which the flow rate is substantially zero.

16. A method of washing a pet, comprising the steps of:
actuating a first actuator on a spray nozzle to generate an exiting water stream;
wetting the pet with the water stream;
actuating a second actuator on the spray nozzle to add a liquid detergent to the exiting water stream;
directing the water stream with detergent into the pet's coat;
returning the second actuator to its unactuated position; and
rinsing the detergent from the pet's coat with the water stream.

17. The method of claim 16 wherein the step of actuating the first actuator involves rotating the first actuator.

18. The method of claim 16 wherein the step of actuating the second actuator involves rotating the second actuator.

19. The method of claim 16 wherein the step of actuating the second actuator involves sliding the second actuator.

20. The method of claim 16 further comprising the step of massaging the detergent into the pet's coat.
